(19) United States
(12) Patent Application Publication
(10) Pub. No.: US 2011/0210643 A1
(43) Pub. Date: Sep. 1, 2011

(54) STATOR CORE SUSPENSION SYSTEM USING SPRING BAR IN PLANE EXTENDING PERPENDICULAR TO STATOR CORE AXIS

(75) Inventors: Anand Shankar Tanavde, Slingerlands, NY (US); Richard Nils Dawson, Voorheesville, NY (US); David Norwood Dorsey, Clifton Park, NY (US); Nathaniel Philip Marshall, Clifton Park, NY (US); Srujana Tayi, Bangalore (IN); John Russell Yagielski, Scotia, NY (US); David Raju Yamarthi, Bangalore (IN)

(73) Assignee: GENERAL ELECTRIC COMPANY, Schenectady, NY (US)

(21) Appl. No.: 12/713,505

(22) Filed: Feb. 26, 2010

(51) Int. Cl. H02K 1/18

(52) U.S. Cl. 310/216.113

(57) ABSTRACT

A stator core suspension system includes a spring bar(s) coupled to a stator core and a frame for vibrationally isolating the stator core from the frame. A longitudinal axis of the spring bar is positioned in a plane extending substantially perpendicular to an axis of the stator core. The stator core suspension system can be arranged in modular suspension sections for selective assembly into a related dynamoelectric machine.

### BACKGROUND OF THE INVENTION

The disclosure relates generally to dynamoelectric machine suspension systems, and more particularly, to a stator core suspension system using spring bar(s) in a plane substantially perpendicular to a stator core axis.

A stator core suspension for a dynamoelectric machine such as a generator or motor has to support the stator core and provide vibration isolation to the supporting structure (e.g., frame), which is mounted to the foundation. For example, large 2-pole generators may require vibration isolation to avoid shaking the foundation to such an extent that the anchorage will be compromised and environmental and health and safety (EHS) floor vibration limits may be exceeded.

FIGS. 1-3 illustrate a conventional stator core suspension 10 including spring bars 12 (see FIG. 2). FIG. 1 shows a cross-sectional side view, FIG. 2 shows a cross-sectional view along line A-A in FIG. 1, and FIG. 3 shows a perspective view. As understood, a plurality of keybars 14 are provided, and each couples to a respective stator core section 13 of a group of circumferentially spaced stator core sections 13 that make up the stator core. Keybars 14 are also mounted to a frame 16 via spring bars 12, which provide vibration isolation. As shown best in FIG. 2, spring bars 12 may be bolted on each side of keybar 14 such that they are mounted circumferentially spaced relative to a stator core section 13 (shown in phantom), and extend in an axially parallel fashion relative to the stator core. As shown in FIG. 3, the suspension is coupled to frame 16 including a number of frame section plates 22. The stiffness of the system is controlled by the cross-section and length of the axially extending spring bars.

### BRIEF DESCRIPTION OF THE INVENTION

A first aspect of the disclosure provides a stator core suspension system comprising: a section member positioned about the stator core, the section member including a first spring bar support and an adjacent, second spring bar support; a spring bar having a first end coupled to the first spring bar support and a second end coupled to the adjacent, second spring bar support such that the spring bar extends in a plane substantially perpendicular to an axis of a stator core; a keybar coupled to the stator core; and a spring-to-keybar member coupling the spring bar intermediate the first and second ends to the keybar.

A second aspect of the disclosure provides a stator core suspension system comprising: a plurality of modular suspension sections adapted to be coupled together, each modular suspension section including: a section member including a plurality of circumferentially spaced spring bar supports; a plurality of spring bars, each spring bar having a first end coupled to a first spring bar support and a second end coupled to an adjacent, second spring bar support such that the plurality of spring bars are longitudinally positioned in a plane; and a keybar coupled to each spring bar intermediate the first and second ends, each keybar configured for coupling to a stator core.

A third aspect of the disclosure provides a dynamoelectric machine comprising: a rotor; a stator core about the rotor; and a stator core suspension system including a plurality of modular suspension sections adapted to be coupled together, each modular suspension section including: a plurality of spring bar supports positioned by a section member in a circumferentially spaced arrangement about the stator core; a plurality of spring bars, each spring bar having a first end coupled to a first spring support and a second end coupled to an adjacent, second spring bar support such that the plurality of spring bars are longitudinally positioned in a plane; and a keybar coupled to each spring bar intermediate the first and second ends, each keybar configured for coupling to a stator core section of a stator core.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional, side view prior art stator core suspension.

FIG. 2 shows a cross-sectional, longitudinal view along line A-A of the prior art suspension of FIG. 1.

FIG. 3 shows a partially cut away, perspective view of the prior art suspension of FIG. 1.

FIG. 4 shows a cross-sectional view of a stator core suspension according to embodiments of the invention.

FIG. 5 shows a side view of a modular suspension section of a stator core suspension including a pair of section members according to embodiments of the invention.

FIG. 6 shows a cross-sectional view of a stator core suspension according to embodiments of the invention, including more spring bars than that of FIG. 4.

FIG. 7 shows a side view of a modular suspension section of a stator core suspension including a single section member according to embodiments of the invention.

FIG. 8 shows a cross-sectional, close-up view of a portion of an alternative embodiment of the stator core suspension.

FIG. 9 shows a cross-sectional view of the stator core suspension as shown in FIG. 8.

FIG. 10 shows a cross-sectional detail of a single spring bar coupled to a spring bar support.

FIG. 11 shows a cross-sectional detail of a pair of spring bars coupled to a spring bar support according to one embodiment.

FIG. 12 shows a cross-sectional detail of a pair of spring bars coupled to a spring bar support according to another embodiment.

FIG. 13 shows a side view of numerous and differently sized modular suspension sections of a stator core suspension according to embodiments of the invention.

FIG. 14 shows a side view of a stator core suspension employing the numerous and differently sized modular suspension sections of FIG. 13.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

A stator core suspension system according to embodiments of the invention includes spring bar(s) coupled to a stator core and a frame for vibrationally isolating the stator core from the frame. In contrast to conventional systems, a longitudinal axis of each spring bar is positioned in a plane extending substantially perpendicular to an axis of the stator core. In this fashion, the suspension system can be constructed in modular suspension sections that can be selectively coupled together to form the stator core suspension for a dynamoelectric machine.

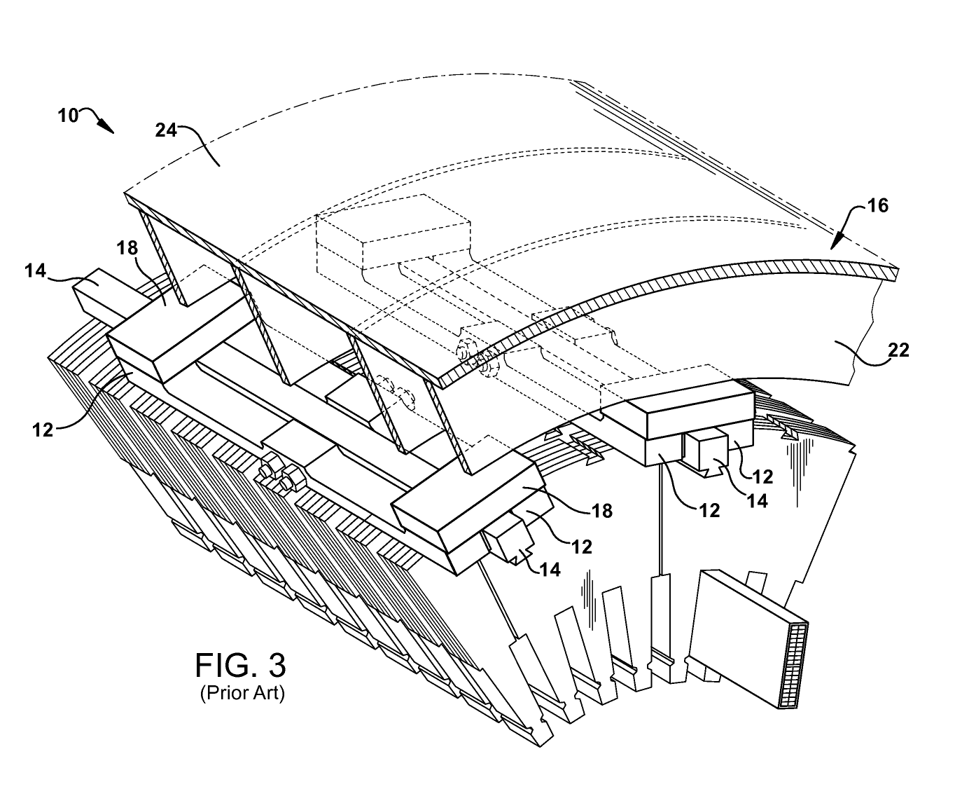

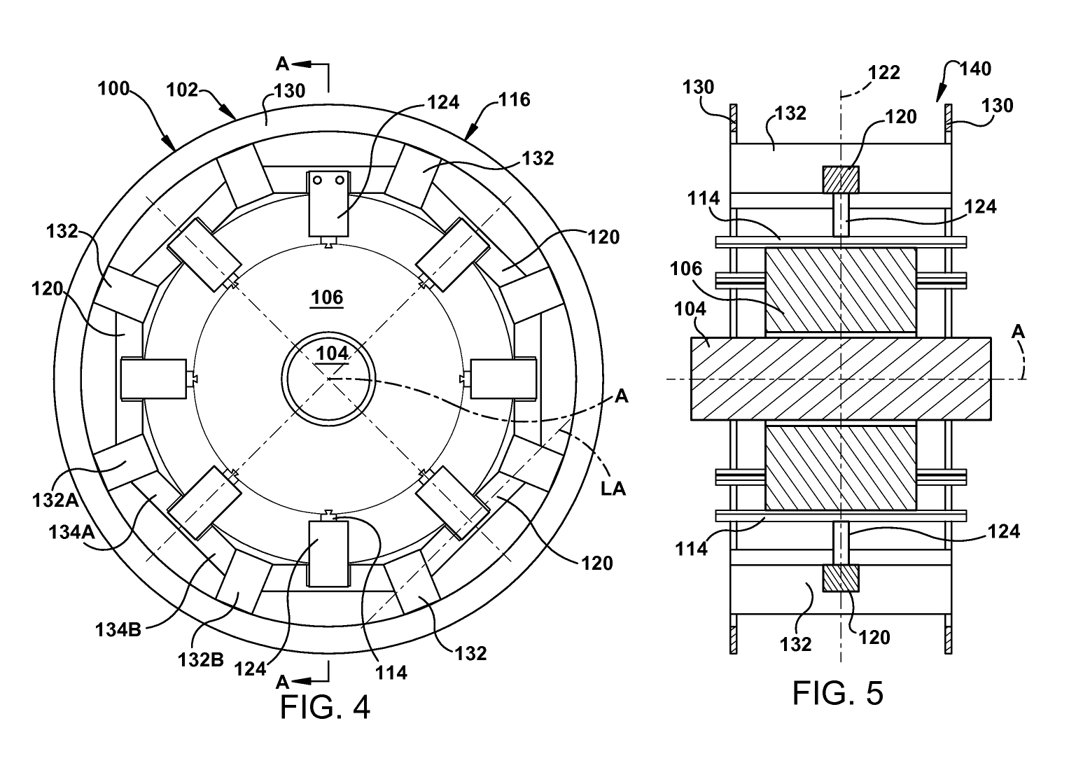

Referring to FIGS. 4-9, a stator core suspension system 100 according to embodiments of the invention are illustrated. Turning to FIG. 4, a cross-sectional view of stator core suspension system 100 (in a simplified form for description purposes) according to embodiments of the invention is shown. Stator core suspension system 100 is positioned for use in a dynamoelectric machine 102 such as a generator or a motor that includes a rotor 104 and a stator core 106 about the rotor. As understood, rotor 104 and stator core 106 are electromagnetically coupled during operation to, in the case of a generator, generate electricity, or, in the case of a motor, use electricity to generate rotational motion. Other features of dynamoelectric machine 102 have been omitted for clarity, but are well within the purview of one with ordinary skill in the art. Although not shown in FIG. 4, it is understood that stator core 106 may be constructed in stator core sections 13 (FIG. 3). Each section 13 includes a keybar slot therein for receiving a keybar 114 (only one labeled in FIG. 4).

Stator core suspension system 100 according to embodiments of the invention includes a spring bar 120 coupled to stator core 106 and a frame 116 for vibrationally isolating the stator core from the frame. As observed best in FIGS. 4 and 5, spring bar(s) 120 include a longitudinal axis (LA)(only shown for one spring bar) that extends in a plane that is substantially perpendicular to axis (A) of stator core 106. Spring bar 120 may be made of any now known or later developed metal or alloy providing appropriate mechanical characteristics.

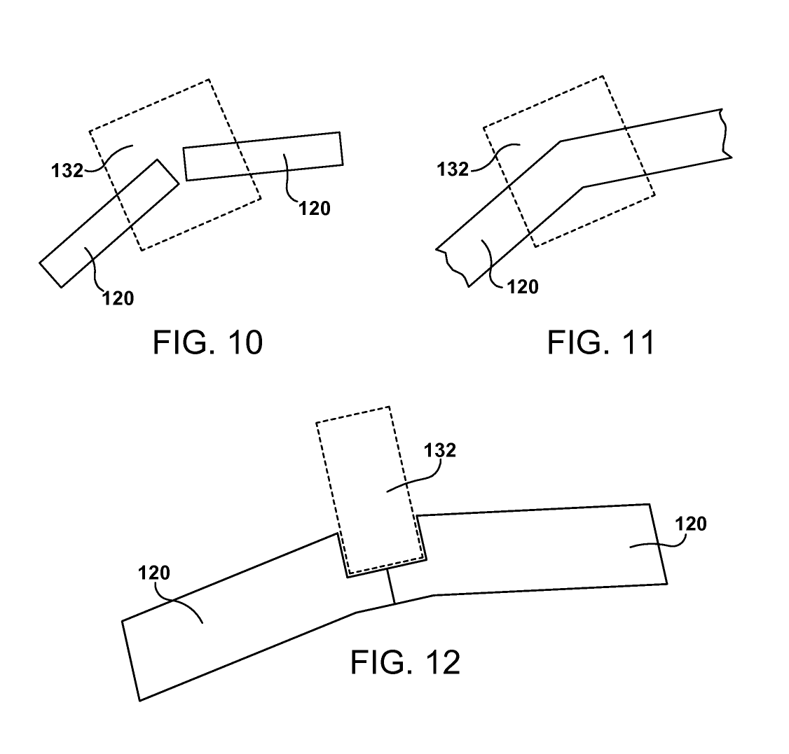

As used herein, “spring bar 120” may include a plurality of separate members that are individually mounted to form suspension system 100, or a single, unitary or close to unitary member. In the former case, as shown in FIGS. 10 and 12, each separate member 120 is fixedly coupled to spring bar supports 132, and in the latter case, as shown in FIG. 11, certain locations on the unitary member 120 are fixedly coupled to spring bar supports 132. In either case, the coupling may be by welding or other mechanical fastening. It is noted, however, that the appearance of these different embodiments is not observable in most of the drawings because the unitary nature or separate nature of spring bar 120 is hidden within spring bar supports 132. Consequently, the different embodiments do not appear any differently between drawings. Hereinafter, unless otherwise necessary, “spring bar 120” will be used to refer to separate members and portions of a single, unitary member, collectively. Each spring bar 120 is flexible, as opposed to other supporting structures, such that it can absorb vibrations of the stator core. In contrast to conventional systems, suspension 100 provides substantially contiguous, circumferentially spaced spring bar(s) 120 about stator core 106.

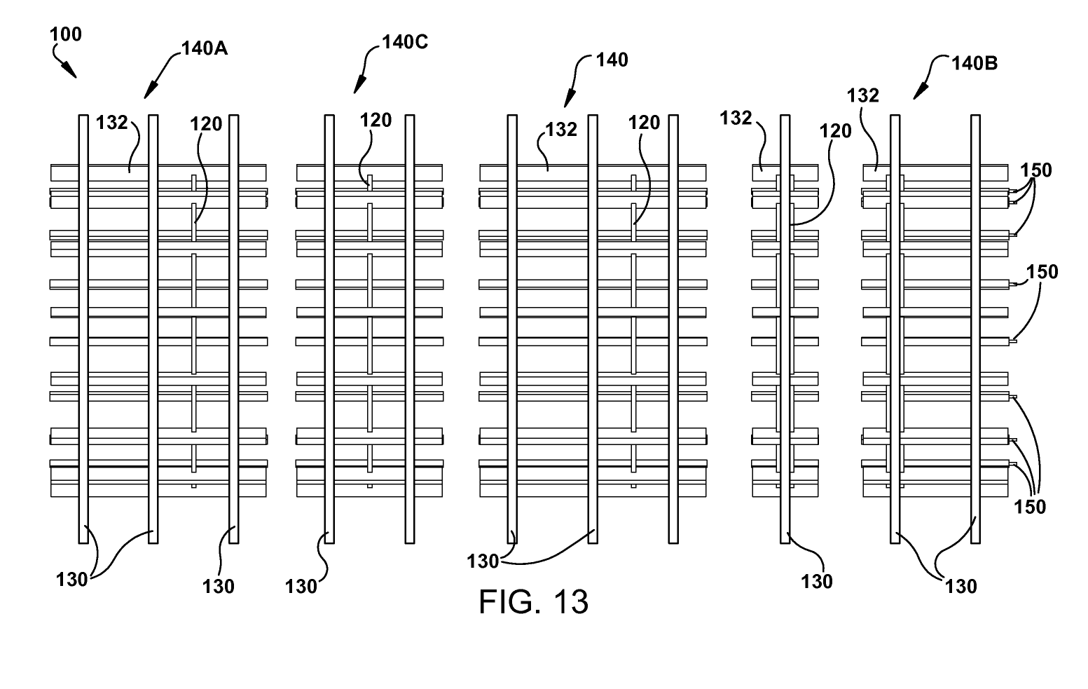

As shown in FIGS. 5 and 13, in one embodiment, spring bar supports 132 can take the form of axially extending spring beams, and can be designed to provide an additional suspension element, thus enabling three dimensional isolation action. Alternatively, spring bar supports 132 may be rigid and not provide any further suspension action. In another alternative, where a suspension module 140 includes only a single section member 130, as shown in FIGS. 7 and 13, spring bars supports 132 need not have an extensive axial length.

Frame 116 may include a section member(s) 130, as will be described in greater detail herein, and any mechanism for coupling suspension system 100 to a foundation in any now known or later developed manner. Each spring bar 120 is coupled to a corresponding keybar 114 (only one labeled in FIG. 4) intermediate the ends of the spring bar by a spring-to-keybar member 124 for supporting stator core 106. That is, by each keybar 114 being positioned within a respective keybar slot (not numbered for clarity) of stator core 106. It is understood that by “intermediate” that exact positioning between the ends of spring bar 120 is not necessary.

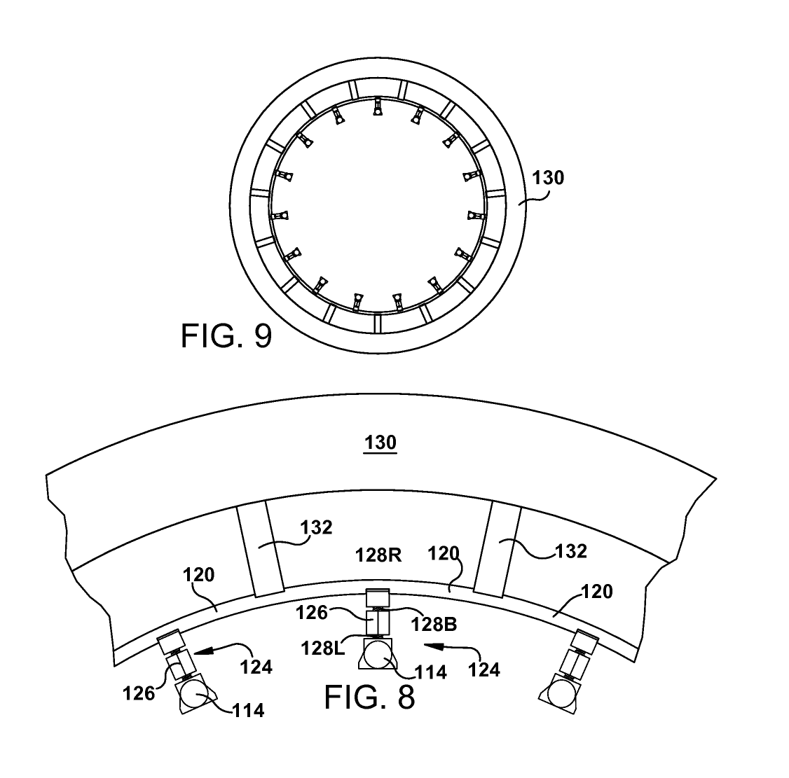

Referring to FIG. 8, each spring-to-keybar member 124 may include a length adjusting device 126. Length adjusting device 126 may include, but is not limited to a turnbuckle device 128. Turnbuckle device 128 may include two threaded members 128L, 128R such that, at one end, it is fixed to spring bar 120 and, at another end, it is fixed to keybar 114. Threaded member 128L, 128R may be threadably connected together by a bolt 128B. One threaded member 128L includes a left-hand thread and the other threaded member 128R includes a right-hand thread such that turning of bolt 128B moves keybar 114 and spring bar 120 closer together or farther apart, depending on which way it is turned. Spring-to-keybar member 124 may be coupled to spring bar 120 and/or keybar 114 in any now known or later developed fashion such as welding, mechanical fasteners like bolts, etc. Spring-to-keybar member 124 can be attached to spring bar 120 and keybar 114 through a threaded connection or a welded connection.

As noted above, in contrast to conventional systems, a longitudinal axis (LA) of spring bar 120 is positioned in a plane 122 extending substantially perpendicular to an axis A of stator core 106. On conventional systems, spring bars 12 (FIG. 3) extend parallel to an axis of the stator core (sections 13 in FIG. 2). In order to accommodate this positioning, in one embodiment, section member 130 extends about stator core 106 and includes a plurality of spring bar supports 132 that are circumferentially spaced about stator core 106. Spring bar supports 132, among other things, provide support for spring bar(s) 120. Although shown as elements extending perpendicularly from spring bar 120, spring bar supports 132 can take a variety of different shapes and forms, and may be made out of any appropriate metal or alloy sufficient to vibrationally support stator core 106. Spring bar supports 132 may be coupled to section member 130 in any now known or later developed fashion, e.g., welding or other mechanical fasteners. Section member 130 may include, for example, a metal or alloy and is generally circular with an open middle through which stator core 106 and rotor 104 extend. Section member 130 is coupled to a foundation (not shown) by the rest of frame 116. Where multiple spring bars 120 are used, see FIG. 4, each spring bar 120 includes a first end 134A coupled to a first spring bar support 132A and an opposite, second end 134B coupled to a second spring bar support 132B that is adjacent to the first spring bar support. Where a single spring bar 120 is used, as shown best in FIG. 11, the spring bar may be supported by various circumferentially spaced spring bar supports 132, e.g., where portions of the spring bar meet. In either case, as noted above, spring bar 120 may be coupled to spring bar supports 132 using, e.g., welding or other mechanical fastening. Section member 130 may be positioned in plane 122, or a plane substantially parallel thereto, extending substantially perpendicular to axis A of stator core 106. An advantage that may be realized in the practice of some embodiments of the described structure is that spring bar supports 132 allow for torsional and bending vibration absorption and tuning thereof, which are not typically addressed by conventional suspensions.

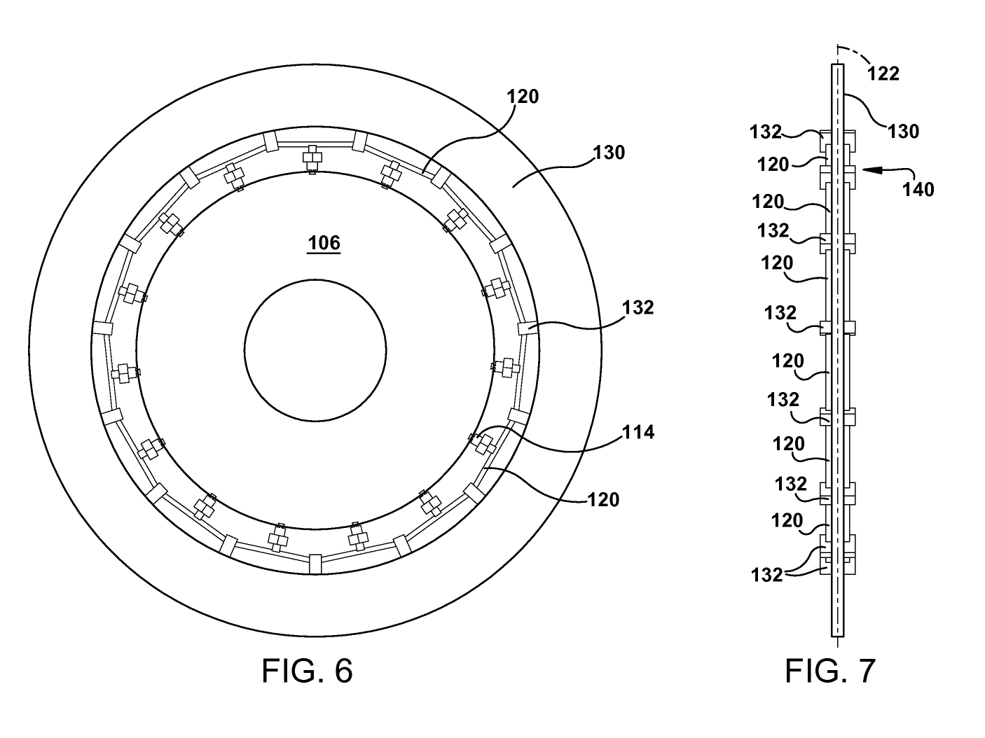

In one embodiment, as shown in FIGS. 4 and 6, where multiple spring bars 120 are used, each spring bar 120 may be substantially linear. Consequently, collectively the spring bars 120 are configured in a substantially polygonal manner in plane 122 (FIGS. 5 and 7). Where a single, continuous spring bar 120 is used, it may appear substantially identical to that shown in FIGS. 4 and 6 even though it is one piece, or nearly one piece. In an alternative embodiment shown in FIGS. 8 and 9, each spring bar 120 may be substantially arcuate, and collectively the separate spring bars are configured in a substantially circular manner in the plane. Again, where a single, continuous and, here, substantially circular spring bar 120 is used, it may appear substantially identical to that shown in FIGS. 8 and 9 even though it is one piece, or nearly one piece. As also observed by comparing FIGS. 4 and 6, the number of separate spring bars or portions of a unitary spring bar can be varied. In the simplified version of FIG. 4, eight spring bars 120 are employed, and in FIG. 6, fifteen spring bars 120 are employed. In operation, any number of spring bars 120 commensurate with keybar slots in stator core 106 may be used.

An advantage that may be realized in the practice of some embodiments of the described structure is that it allows for modularization of stator core suspension system 100, which, among other things, reduces cost and cycle time for manufacture. More specifically, any number of section members 130 may be fitted with a plurality of axially spaced spring bars 120 to form modular suspension sections 140 that may be selectively coupled together to form stator core suspension system 100. For example, in the FIG. 5 embodiment, a pair of section members 130 are axially spaced relative to stator core 106, and spring bar supports 132 extend (axially) between the pair of section members. That is, spring bar supports 132 couple and axially position section members 130 relative to one another. In this case, the spring bars 120 may be positioned between the pair of section members 130. In another example, as shown in FIGS. 6 and 7, one section member 130 may support a plurality of spring bars 120 thereon. In this case, spring bar supports 132 may not have any substantial axial extent other than that which may be necessary to couple modular suspension sections 140.

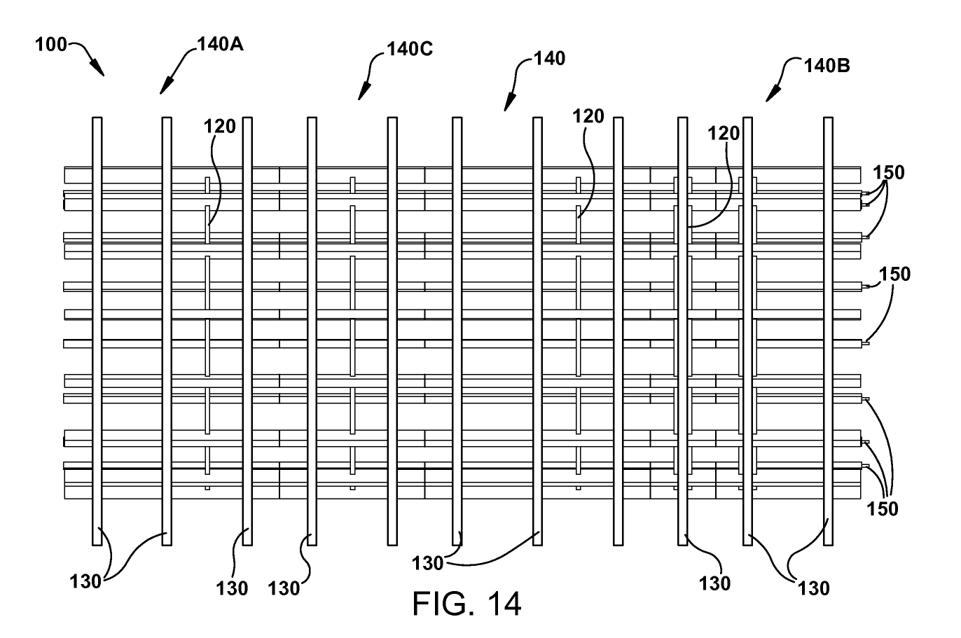

Turning to FIG. 13, a number of different sized modular suspension sections 140 are illustrated for selective coupling into a stator core suspension system 100, which is shown in an assembled manner in FIG. 14. As illustrated, each modular suspension section 140 may include any desired number of section members 130. Spring bars 120 may be positioned in practically any axial location within a modular suspension section 140. For example, for modular suspension section 140A (FIG. 13), which includes three section members 130, spring bars 120 are positioned between two adjacent section members 130 thereof, but not between the other adjacent section members 130 thereof In some instances, a modular suspension section 140B may have spring bars 120 omitted. Each modular suspension section, e.g., 140A, may be coupled to an adjacent modular suspension section, e.g., 140C, by, for example, welding of ends of adjacent spring bar supports 132 as shown in FIG. 14. Threaded ends 150 of the keybars are shown on the far right side in FIG. 14.

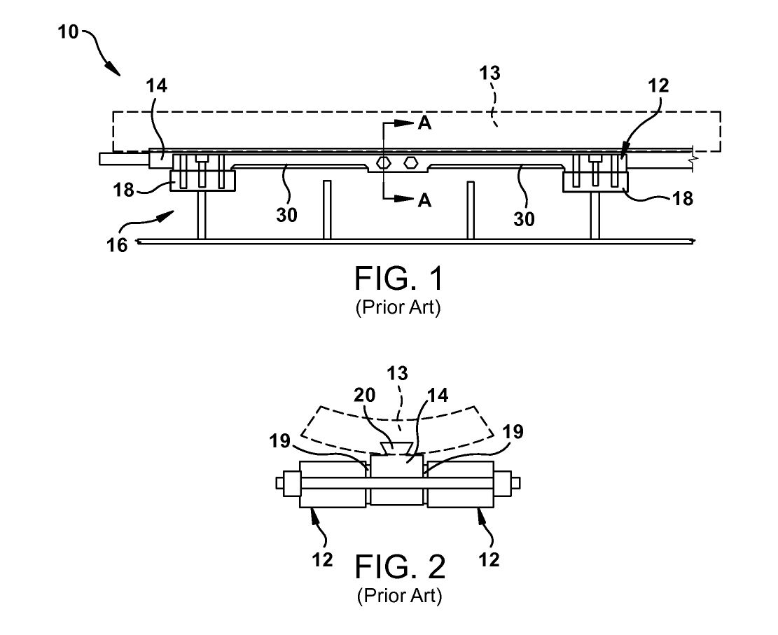

An advantage that may be realized in the practice of some embodiments of the described structure is that radial, tangential and axial spring stiffness of suspension system 100 can be tuned to meet specific isolation performance. In particular, spring stiffness tuning can be achieved by appropriately sizing cross sectional dimensions and length of components, e.g., spring bars 120, spring bar supports 132, etc., across the entire axial extent of stator core 106 or at particular axial positions along stator core 106. This ability to tune stiffness more precisely is in contrast to conventional suspensions, where stiffness is mainly dependent upon the axial span of spring bars 12 (FIGS. 1-3), which mandates that the performance of the isolation changes as the machine length changes. In addition, according to embodiments of the invention, the radial, tangential and axial spring stiffness of suspension system 100 can be tuned to control the isolation in a specific plane or direction since suspension system 100 provides structure capable of adjustment in all three dimensions. As the length of dynamoelectric machine 102 grows axially, additional modular suspension sections 140 can be added to provide uniform suspension performance. Furthermore, the radial space required to accommodate suspension system 100 is smaller than the conventional bolted or welded spring bar systems and, hence, a bigger diameter stator core 106 can be accommodated in frame 116, which enables a higher megawatt (MW) rating or power in the same volume.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A stator core suspension system comprising:
a section member positioned about the stator core, the section member including a first spring bar support and an adjacent, second spring bar support;
a spring bar having a first end coupled to the first spring bar support and a second end coupled to the adjacent, second spring bar support such that the spring bar extends in a plane substantially perpendicular to an axis of a stator core;
a keybar coupled to the stator core; and
a spring-to-keybar member coupling the spring bar intermediate the first and second ends to the keybar.

2. The stator core suspension system of claim 1, wherein the section member includes a plurality of spring bar supports that are circumferentially spaced about the stator core, and the spring bar includes a plurality of spring bars, each spring bar having a first end coupled to a respective first spring bar support and a second end coupled to a respective adjacent, second spring bar support.

3. The stator core suspension system of claim 2, wherein the longitudinal axis of each spring bar is positioned in the plane extending substantially perpendicular to the axis of the stator core.

4. The stator core suspension system of claim 2, wherein each of the plurality of spring bars is substantially linear, and collectively the spring bars are configured in a substantially polygonal manner in the plane.

5. The stator core suspension system of claim 2, wherein each of the plurality of spring bars is substantially arcuate, and collectively the spring bars are configured in a substantially circular manner in the plane.

6. The stator core suspension system of claim 1, wherein the section member is positioned in a plane extending substantially perpendicular to the axis of the stator core.

7. The stator core suspension system of claim 1, wherein the section member includes a pair of section members axially spaced relative to the stator core, and the spring bar supports extend between the pair of section members.

8. The stator core suspension system of claim 1, wherein the spring-to-keybar member includes a length adjusting device.

9. The stator core suspension system of claim 8, wherein the length adjusting device includes a turnbuckle device.

10. The stator core suspension system of claim 8, wherein a first end of the length adjusting device is fixed to the spring bar and a second, opposite end of the length adjusting device is fixed to the keybar.

11. A stator core suspension system comprising:
a plurality of modular suspension sections adapted to be coupled together, each modular suspension section including:
a section member including a plurality of circumferentially spaced spring bar supports;
a plurality of spring bars, each spring bar having a first end coupled to a first spring bar support and a second end coupled to an adjacent, second spring bar support such that the plurality of spring bars are longitudinally positioned in a plane; and
a keybar coupled to each spring bar intermediate the first and second ends, each keybar configured for coupling to a stator core.

12. The stator core suspension system of claim 11, wherein the section member includes a pair of section members that are axially spaced relative to the stator core, and the spring bar supports extend axially relative to the stator core to couple the section members, and the plane extends substantially perpendicular to the stator core.

13. The stator core suspension system of claim 11, wherein each of the plurality of spring bars is substantially linear, and collectively the spring bars are configured in a substantially polygonal manner in the plane.

14. The stator core suspension system of claim 11, wherein each of the plurality of spring bars is substantially arcuate, and collectively the spring bars are configured in a substantially circular manner in the plane.

15. The stator core suspension system of claim 11, wherein each keybar is coupled to a respective spring bar by a spring-to-keybar member.

16. The stator core suspension system of claim 15, wherein the spring-to-keybar member includes a length adjusting device.

17. The stator core suspension system of claim 16, wherein the length adjusting device includes a turnbuckle device.

18. The stator core suspension system of claim 16, wherein a first end of the length adjusting device is fixed to the spring bar and a second, opposite end of the length adjusting device is fixed to the keybar.

19. A dynamoelectric machine comprising:
a rotor;
a stator core about the rotor; and
a stator core suspension system including a plurality of modular suspension sections adapted to be coupled together, each modular suspension section including:
a plurality of spring bar supports positioned by a section member in a circumferentially spaced arrangement about the stator core;
a plurality of spring bars, each spring bar having a first end coupled to a first spring support and a second end coupled to an adjacent, second spring bar support such that the plurality of spring bars are longitudinally positioned in a plane; and
a keybar coupled to each spring bar intermediate the first and second ends, each keybar configured for coupling to a stator core section of a stator core.

20. The stator core suspension system of claim 19, wherein the section member includes a pair of section members that are axially spaced relative to the stator core, and the spring bar supports extend axially relative to the stator core to couple the section members, and the plane extends substantially perpendicular to the stator core.
